(19) United States
(12) Patent Application Publication
(10) Pub. No.: US 2023/0292961 A1
(43) Pub. Date: Sep. 21, 2023

(54) DELIVERY DEVICE

(71) Applicant: Chong Suk LEE, Gimpo-si (KR)

(72) Inventor: Chong Suk LEE, Gimpo-si (KR)

(21) Appl. No.: 18/117,463

(22) Filed: Mar. 5, 2023

(30) Foreign Application Priority Data
Mar. 15, 2022 (KR) 10-2022-0031744

(51) Int. Cl. A47J 47/14

(52) U.S. Cl. CPC A47J 47/14

(57) ABSTRACT

A delivery device according to an embodiment of the present disclosure may include a delivery box and a controller. The delivery box may include a temperature adjustment device disposed therein to adjust its internal temperature. The controller may provide a control signal to adjust the temperature of the delivery box.

The delivery device according to the present disclosure may deliver delivery food to a customer under an optimal condition by adjusting the internal temperature of the delivery box based on the control signal provided by the controller.

### CROSS-REFERENCE TO RELATED APPLICATION(S)

This application claims benefit of priority to Korean Patent Application No. 10-2022-0031744 filed on Mar. 15, 2022 in the Korean Intellectual Property Office, the disclosure of which is incorporated herein by reference in its entirety.

### BACKGROUND

### 1. FIELD

The present disclosure relates to a delivery device.

### 2. DESCRIPTION OF RELATED ART

In recent years, various studies are being conducted to deliver food more efficiently as the demand for the delivery food has been increased rapidly due to spread of Corona virus.

### RELATED ART DOCUMENT

### Patent Document

Korean Patent No. 10-2325412 (registered on Nov. 5, 2021)

### SUMMARY

An aspect of the present disclosure may provide a delivery device which may deliver delivery food to a customer under an optimal condition by adjusting an internal temperature of a delivery box based on a control signal provided by a controller.

A delivery device according to an embodiment of the present disclosure may include a delivery box and a controller. The delivery box may include a temperature adjustment device disposed therein to adjust its internal temperature. The controller may provide a control signal to adjust the temperature of the delivery box.

The delivery box may be classified into a plurality of storage areas, and a temperature of each of the storage areas may be determined based on the control signal.

The delivery device may further include a data recognition unit. The data recognition unit may recognize a receipt of a delivery product disposed in each of the plurality of storage areas to determine a delivery location, a type of the delivery product, and a company name of the delivery product.

When the delivery product is disposed in one selected area of the storage areas, a temperature of the selected area may be primarily set to a predetermined storage temperature for each product based on the type of the delivery product.

The temperature of the selected area may be secondarily adjusted based on the control signal provided from the controller.

The delivery device may further include an area recommendation unit. The area recommendation unit may recommend the storage area where each delivery product is disposed when the plurality of delivery products are provided.

The area recommendation unit may recommend the storage area by varying a distance between the delivery products based on the storage temperature for each product depending on the type of the delivery product.

The delivery device may further include a location recognition device recognizing a location. When arriving at a first location, the delivery device may compare the first location with the delivery location of the delivery product disposed in each of the plurality of storage areas to allow the storage area to protrude in a first direction, the storage area corresponding to the delivery product having the smallest distance between the first location and the delivery location.

When arriving at the first location, the delivery device may compare the first location with the delivery location of the delivery product disposed in each of the plurality of storage areas to allow the storage areas to protrude in the first direction, the storage areas each corresponding to the delivery product having a smaller distance than a predetermined reference distance when there are the plurality of delivery products each having a smaller distance between the first location and the delivery location than the reference distance.

The delivery box may further include a first display device therein. When arriving at the first location, the delivery device may compare the first location with the delivery location of the delivery product disposed in each of the plurality of storage areas, and the first display device then distinguish and display the storage area corresponding to the delivery product having the smallest distance between the first location and the delivery location.

The delivery device may further include a second display device disposed outside the delivery device, wherein the second display device recognizes a distance to an object approaching from the rear, and has lower brightness as the distance is smaller.

The second display device may display the company name of the delivery product disposed in each of the storage areas at predetermined time intervals.

In addition to the above-mentioned technical tasks of the present disclosure, other features and advantages of the present disclosure may be described below, or may be clearly understood by those skilled in the art to which the present disclosure pertains from such description and explanation.

### BRIEF DESCRIPTION OF DRAWINGS

FIG. 1 is a view showing a delivery device according to embodiments of the present disclosure.

FIG. 2 is a view showing an example of storage areas included in the delivery device of FIG. 1.

FIG. 3 is a view showing an embodiment of the delivery device of FIG. 1.

FIG. 4 is a view for explaining information recognized from a receipt by the delivery device of FIG. 1.

FIG. 5 is a view for explaining a storage temperature for each product applied to the delivery device of FIG. 1.

FIG. 6 is a view showing an example of an operation of a controller included in the delivery device of FIG. 1.

FIG. 7 is a view for explaining another embodiment of the delivery device of FIG. 1.

FIGS. 8 to 10 are views for explaining another embodiment of the delivery device of FIG. 1.

FIGS. 11 and 12 are views for explaining an operation of a second display device included in the delivery device of FIG. 1.

### DETAILED DESCRIPTION

In the specification, in adding reference numerals to components throughout the drawings, it is to be noted that like reference numerals designate like components even though components are shown in different drawings.

Meanwhile, meanings of the terms described in this specification should be understood as follows.

Terms of singular forms used herein are intended to include their plural forms unless explicitly indicated otherwise, and a scope of the present disclosure is not limited by the terms used herein.

It is to be understood that a term “include” or “have” does not preclude the presence or addition of one or more other features, numerals, operations, components, parts or combinations thereof, which is mentioned in the specification.

Hereinafter, embodiments of the present disclosure are described in detail with reference to the accompanying drawings.

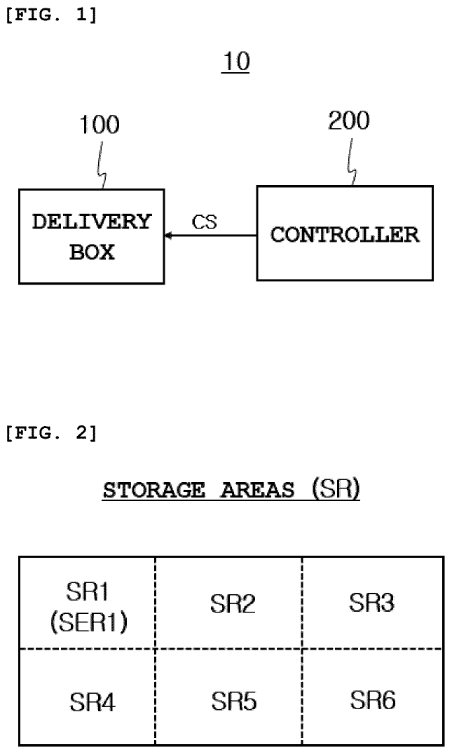

FIG. 1 is a view showing a delivery device according to embodiments of the present disclosure; and FIG. 2 is a view showing an example of storage areas included in the delivery device of FIG. 1.

Referring to FIGS. 1 and 2, a delivery device 10 according to an embodiment of the present disclosure may include a delivery box 100 and a controller 200. The delivery box 100 may include a temperature adjustment device disposed therein to adjust its internal temperature. For example, the temperature adjustment device may be an electronic device used to maintain a temperature of food inside the delivery box 100, and in a case of hot food such as stew, the internal temperature of the delivery box 100 may be increased through the temperature adjustment device. In addition, in a case of cold food such as Naengmyeon (Korean cold noodles), the internal temperature of the delivery box 100 may be lower through the temperature adjustment device.

The controller 200 may provide a control signal CS for adjusting the temperature of the delivery box 100. For example, the control signal CS may include a first temperature control signal and a second temperature control signal. The controller 200 may increase the internal temperature of the delivery box 100 by providing the first temperature control signal to the temperature adjustment device, and also lower the internal temperature of the delivery box 100 by providing the second temperature control signal to the temperature adjustment device.

In an embodiment, the delivery box 100 may be classified into a plurality of storage areas SRs, and a temperature of each of the storage areas SRs may be determined based on the control signal CS. For example, the delivery box 100 may include the plurality of storage areas SRs, and the plurality of storage areas SRs may include a first storage area SR1 to a sixth storage area SR6. A temperature of each of the first storage area SR1 to the sixth storage area SR6 may be determined based on the control signal CS provided from the controller 200.

For example, the controller 200 may provide a 1-1-th temperature control signal to increase the temperature of the first storage area SR1, and the controller 200 may provide 2-1-th temperature control signal to lower the temperature of the first storage area SR1. In the same way, the controller 200 may provide a 1-6-th temperature control signal to increase the temperature of the sixth storage area SR6, and the controller 200 may provide 2-6-th temperature control signal to lower the temperature of the sixth storage area SR6.

The delivery device 10 according to the present disclosure may deliver delivery food to a customer under an optimal condition by adjusting the internal temperature of the delivery box 100 based on the control signal CS provided by the controller 200.

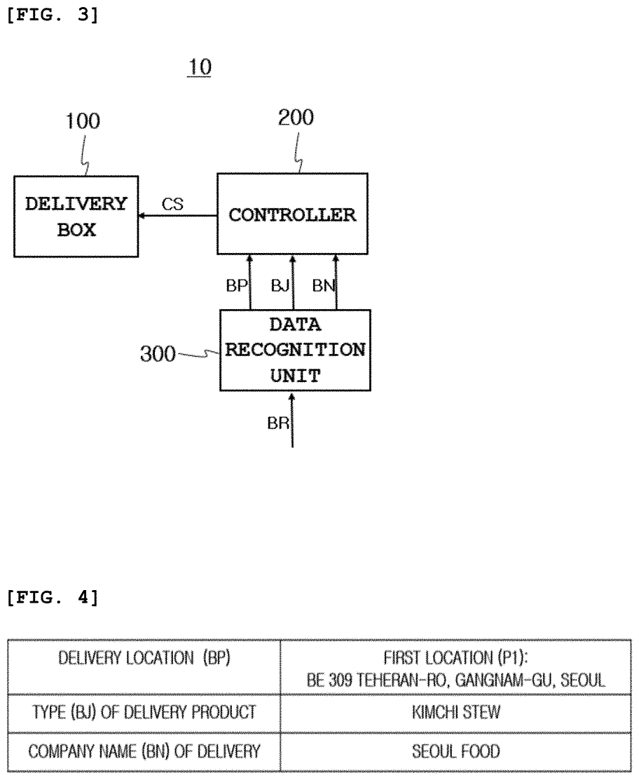

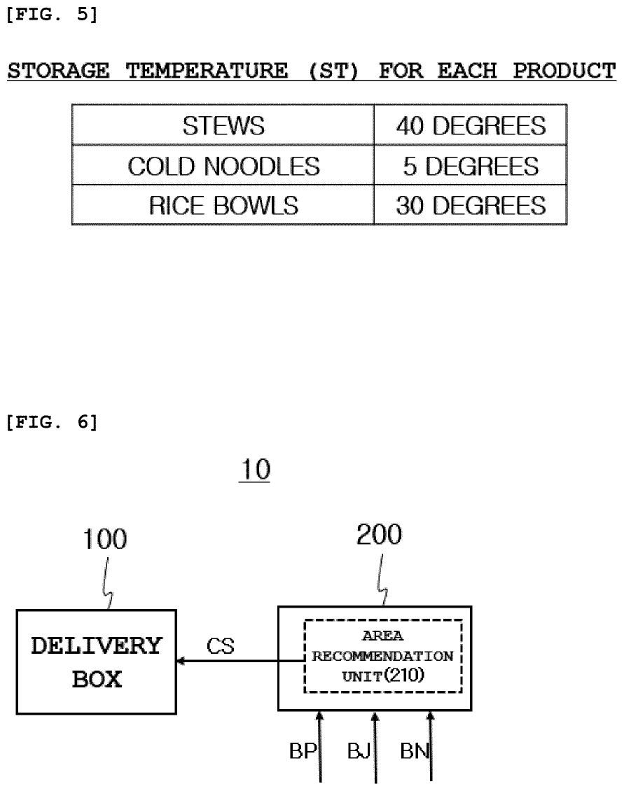

FIG. 3 is a view showing an embodiment of the delivery device of FIG. 1; FIG. 4 is a view for explaining information recognized from a receipt by the delivery device of FIG. 1; and FIG. 5 is a view for explaining a storage temperature for each product applied to the delivery device of FIG. 1.

Referring to FIGS. 1 to 5, the delivery device 10 may further include a data recognition unit 300. The data recognition unit 300 may recognize a receipt BR of a delivery product BM disposed in each of the plurality of storage areas SR to determine a delivery location BP, a type BJ of the delivery product BM, and a company name BN of the delivery product BM. For example, the plurality of storage areas SRs may include the first storage area SR1 to the sixth storage area SR6. The delivery products BMs requested by the customers may be disposed in the first storage area SR1 to the sixth storage area SR6. The receipt BR may be attached to the delivery product BM. The receipt BR may be recognized by the data recognition unit 300 before the delivery product BM is disposed in the storage area. A method of recognizing information by the data recognition unit 300 may use various methods such as a method of recognizing characters included in an image or a method of recognizing information through a QR code.

For example, the type BJ of a first delivery product BM1 among the plurality of delivery products BMs may be Kimchi stew, and the delivery location BP of the first delivery product BM1 may be 309 Teheran-ro, Gangnam-gu, Seoul, Republic of Korea. In addition, the company name BN of the first delivery product BM1 that produces the first delivery product BM1 may be “Seoul Food.” In this case, the receipt BR of the first delivery product BM1 may include the delivery location BP of the first delivery product BM1, the type BJ of the first delivery product BM1, and information on the company name BN of the first delivery product BM1. Before a delivery driver starts delivery of the first delivery product BM1, the data recognition unit 300 may scan the receipt BR of the first delivery product BM1 to be disposed in each of the plurality of storage areas SRs to determine the delivery location BP of the first delivery product BM1, the type BJ of the first delivery product BM1, and the company name BN of the first delivery product BM1. The delivery device 10 according to the present disclosure may then be operated by matching the information on the first delivery product BM1 with the first storage area SR1 when the first delivery product BM1 is disposed in the first storage area SR1.

In an embodiment, when the delivery product BM is disposed in one selected area SER1 of the storage areas SRs, a temperature of the selected area SER1 may be primarily set to a predetermined storage temperature ST for each product based on the type BJ of the delivery product BM. For example, the plurality of storage areas SRs may include the first storage area SR1 to the sixth storage area SR6. The first storage area SR1 may be the selected area SER1 when the first delivery product BM1 is disposed by selecting the first storage area SR1 from the first storage area SR1 to the sixth storage area SR6. Here, the temperature of the first storage area SR1 may be set to the predetermined storage temperature ST for each product.

For example, the type BJ of the delivery product BM may include stews, cold noodles, and rice bowls. In the case of stews, a temperature required to maintain a quality of food may be 40 degrees, and in the case of cold noodles, a temperature required to maintain a texture of the noodles may be 5 degrees. In addition, in the case of rice bowls, a temperature required to maintain the rice warm may be 30 degrees. For example, the type BJ of the first delivery product BM1 detected by the data recognition unit 300 may be Kimchi stew. When the first delivery product BM1 is disposed in the first storage area SR1, the delivery device 10 according to the present disclosure may primarily set the temperature of the first storage area SR1 to 40 degrees corresponding to the stew.

In an embodiment, the temperature of the selected area SERI may be secondarily adjusted based on the control signal CS provided from the controller 200. For example, a user of the delivery device 10 according to the present disclosure may secondarily adjust the temperature of the first storage area SR1 through the control signal CS of the controller 200 in consideration of a driving condition including weather.

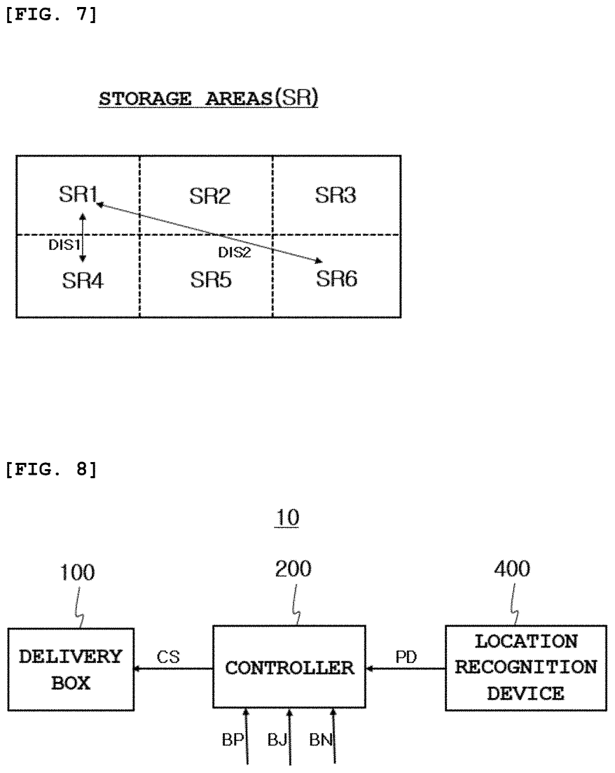

FIG. 6 is a view showing an example of an operation of the controller included in the delivery device of FIG. 1; and FIG. 7 is a view for explaining another embodiment of the delivery device of FIG. 1.

Referring to FIGS. 1 to 7, the delivery device 10 may further include an area recommendation unit 210. The area recommendation unit 210 may recommend the storage area where each delivery product BM is disposed when the plurality of delivery products BMs are provided.

In another embodiment, the area recommendation unit 210 may recommend the storage area by varying a distance between the delivery products BM based on the storage temperature ST for each product depending on the type BJ of the delivery product BM. For example, the plurality of storage areas SRs may include the first storage area SR1 to the sixth storage area SR6. Kimchi stew corresponding to the first delivery product BM1 may be disposed in the first storage area SR1 at a first time. After the first time, a second delivery product may be recognized through the data recognition unit 300 at a second time. Here, the type BJ of the second delivery product may be rice bowls. In this case, the area recommendation unit 210 may recommend the storage area of the second delivery product as the fourth storage area SR4 closest to the first storage area SR1 based on a difference between the storage temperature ST for each product of the stews corresponding to the first delivery product BM1 and the storage temperature ST for each product of the rice bowls corresponding to the second delivery product. After the second time, a third delivery product may be recognized through the data recognition unit 300 at a third time. Here, the type BJ of the third delivery product may be cold noodles. In this case, the area recommendation unit 210 may recommend the storage area of the third delivery product as the sixth storage area SR6 farthest from the first storage area SR1 based on a difference between the storage temperature ST for each product of the stews corresponding to the first delivery product BM1 and the storage temperature ST for each product of the cold noodles corresponding to the third delivery product.

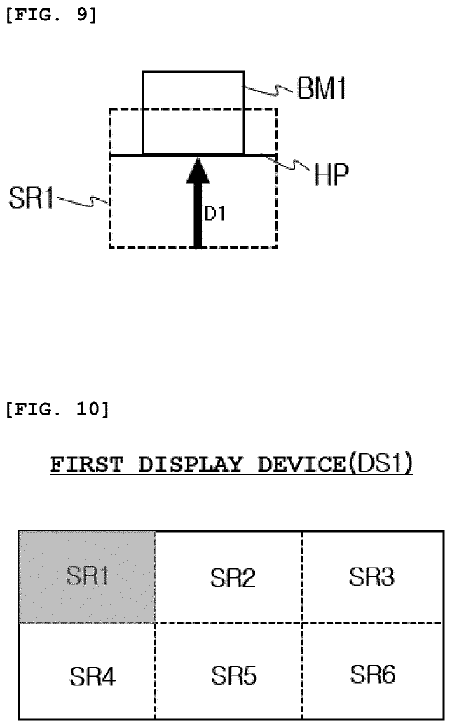

FIGS. 8 to 10 are views for explaining another embodiment of the delivery device of FIG. 1.

Referring to FIGS. 1 through 10, the delivery device 10 may further include a location recognition device 400 recognizing a location. When arriving at a first location P1, the delivery device 10 may compare the first location P1 with the delivery location BP of the delivery product BM disposed in each of the plurality of storage areas SRs to allow the storage area to protrude in a first direction D1,the storage area corresponding to the delivery product BM having the smallest distance between the first location P1 and the delivery location BP.

For example, Kimchi stew to be delivered to the first location P1 may be disposed in the first storage area SR1 among the plurality of storage areas SRs, and a rice bowl to be delivered to a second location may be disposed in the fourth storage area SR4. In addition, cold noodles to be delivered to a third location may be disposed in the sixth storage area SR6. In this case, a motorcycle carrying the delivery device 10 may arrive at the first location P1. The first location P1 may be 309 Teheran-ro, Gangnam-gu, Seoul. In this case, the delivery device 10 may recognize the first location P1 through the location recognition device 400, and compare the first location P1 and the information on the first delivery product BM1 to the third delivery product to determine the first storage area SR1 corresponding to the storage area of the first delivery product BM1. The delivery device 10 according to the present disclosure may then raise a lower plate HP disposed in the first storage area SR1 in the first direction Dl for the delivery driver may easily check the first delivery product BM1.

In another embodiment, when arriving at the first location P1, the delivery device 10 may compare the first location P1 with the delivery location BP of the delivery product BM disposed in each of the plurality of storage areas SRs to allow the storage areas to protrude in the first direction D1, the storage areas each corresponding to the delivery product BM having a smaller distance than a predetermined reference distance when there are the plurality of delivery products BMs each having a smaller distance between the first location P1 and the delivery location BP than the reference distance. For example, Kimchi stew to be delivered to the first location P1 may be disposed in the first storage area SR1 among the plurality of storage areas SRs, and the rice bowl to be delivered to the second location may be disposed in the fourth storage area SR4. In addition, cold noodles to be delivered to the third location may be disposed in the sixth storage area SR6. Here, the predetermined reference distance may be 100 m, and the reference distance may be a distance set by the user.

For example, the motorcycle carrying the delivery device 10 may arrive at the first location P1. In this case, the delivery device 10 according to the present disclosure may calculate a distance between the delivery location BP of the first delivery product BM1 and the first location P1, and calculate a distance between the delivery location BP of the second delivery product and the first location P1. In the same way, the delivery device 10 may calculate a distance between the delivery location BP of the third delivery product and the first location P1. Here, the distance between the delivery location BP of the first delivery product BM1 and the first location P1 and the distance between the delivery location BP of the second delivery product and the first location P1 may be smaller than the reference distance of 100 m, and the distance between the delivery location BP of the third delivery product and the first location P1 may be greater than 100 m. In this case, the lower plate HP disposed in each of the first storage area SR1 where the first delivery product BM1 is disposed and in the fourth storage area SR4 where the second delivery product is disposed may be raised in the first direction D1 for the delivery driver to easily check the first delivery product BM1 and the second delivery product. In this case, the delivery driver may deliver the first delivery product BM1 and the second delivery product within a short delivery distance all together.

In another embodiment, the delivery box 100 may further include a first display device DS1 therein. When arriving at the first location P1, the delivery device 10 may compare the first location P1 with the delivery location BP of the delivery product BM disposed in each of the plurality of storage areas SRs, and the first display device DS1 may then distinguish and display the storage area corresponding to the delivery product BM having the smallest distance between the first location P1 and the delivery location BP.

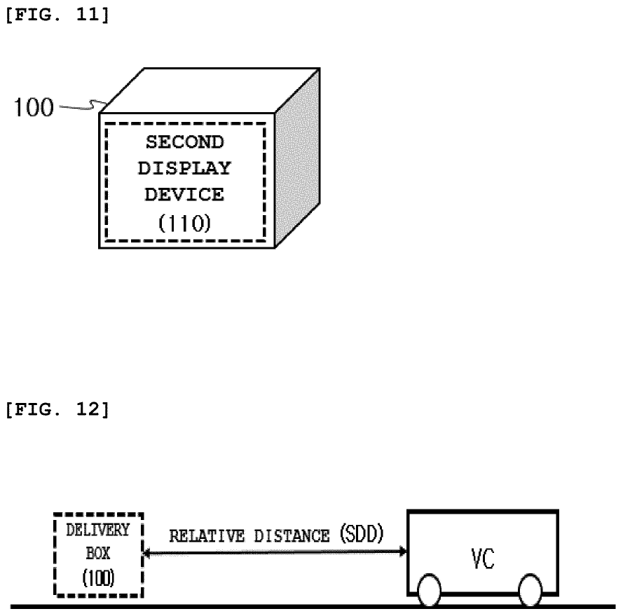

FIGS. 11 and 12 are views for explaining an operation of a second display device included in the delivery device of FIG. 1.

In another embodiment, the delivery device 10 may further include a second display device 110 disposed outside the delivery device 10. The second display device 110 may recognize a distance to an object approaching from the rear, and lower brightness as the distance is smaller. For example, the delivery device 10 according to the present disclosure may be disposed at the rear of the motorcycle. The second display device 110 disposed on the rear side of the delivery device 10 may adjust the brightness not to obstruct the view of a vehicle approaching from the rear of the motorcycle. The second display device 110 may have higher brightness as a relative distance SDD between the second display device 110 and a vehicle VC approaching from the rear is increased, and have the lower brightness as the relative distance SDD is smaller. In addition, a lamp may be disposed on a dashboard of the motorcycle for a motorcyclist to check the relative distance SDD between the second display device 110 and the vehicle VC approaching from the rear. For example, as the relative distance is smaller, the color of the lamp may be sequentially changed in an order of gray, yellow, and red. In addition, a warning speaker may be disposed on the motorcycle for the motorcyclist to check the relative distance SDD between the second display device 110 and the vehicle VC approaching from the rear. For example, as the relative distance is smaller, intensity of a warning sound generated from the warning speaker may be increased.

In another embodiment, the second display device 110 may display the company name BN of the delivery product BM disposed in each of the storage areas SRs at predetermined time intervals. A delivery company using the delivery device 10 according to the present disclosure may display advertisement through the second display device 110. The company name BN of the delivery product BM that is recognized by the data recognition unit 300 may be transmitted to the second display device 110 to be displayed at the predetermined time intervals. In addition, the second display device 110 may also be used for a separate advertisement.

The delivery device 10 according to the present disclosure may deliver the delivery food to the customer under the optimal condition by adjusting the internal temperature of the delivery box 100 based on the control signal CS provided by the controller 200.

As set forth above, the present disclosure as described above may provide the following effects.

The delivery device according to the present disclosure may deliver the delivery food to the customer under the optimal condition by adjusting the internal temperature of the delivery box based on the control signal provided by the controller.

In addition, other features and advantages of the present disclosure may be newly identified through the embodiments of the present disclosure.

In addition to the above-mentioned technical tasks of the present disclosure, other features and advantages of the present disclosure may be described below, or may be clearly understood by those skilled in the art to which the present disclosure pertains from such description and explanation.

What is claimed is:

1. A delivery device comprising:
a delivery box including a temperature adjustment device disposed therein to adjust its internal temperature; and
a controller providing a control signal for adjusting the temperature of the delivery box.

2. The delivery device of claim 1, wherein the delivery box is classified into a plurality of storage areas, and a temperature of each of the storage areas is determined based on the control signal.

3. The delivery device of claim 2, further comprising a data recognition unit recognizing a receipt of a delivery product disposed in each of the plurality of storage areas to determine a delivery location, a type of the delivery product, and a company name of the delivery product.

4. The delivery device of claim 3, wherein when the delivery product is disposed in one selected area of the storage areas, a temperature of the selected area is primarily set to a predetermined storage temperature for each product based on the type of the delivery product.

5. The delivery device of claim 4, wherein the temperature of the selected area is secondarily adjusted based on the control signal provided from the controller.

6. The delivery device of claim 5, further comprising an area recommendation unit recommending the storage area where each delivery product is disposed when the plurality of delivery products are provided.

7. The delivery device of claim 6, wherein the area recommendation unit recommends the storage area by varying a distance between the delivery products based on the storage temperature for each product depending on the type of the delivery product.

8. The delivery device of claim 7, further comprising a location recognition device recognizing a location,
wherein when arriving at a first location, the delivery device compares the first location with the delivery location of the delivery product disposed in each of the plurality of storage areas to allow the storage area to protrude in a first direction, the storage area corresponding to the delivery product having the smallest distance between the first location and the delivery location.

9. The delivery device of claim 8, wherein when arriving at the first location, the delivery device compares the first location with the delivery location of the delivery product disposed in each of the plurality of storage areas to allow the storage areas to protrude in the first direction, the storage areas each corresponding to the delivery product having a smaller distance than a predetermined reference distance when there are the plurality of delivery products each having a smaller distance between the first location and the delivery location than the reference distance.

10. The delivery device of claim 9, wherein the delivery box further , includes a first display device therein, and
when arriving at the first location, the delivery device compares the first location with the delivery location of the delivery product disposed in each of the plurality of storage areas, and the first display device then distinguishes and displays the storage area corresponding to the delivery product having the smallest distance between the first location and the delivery location.

11. The delivery device of claim 10, further comprising a second display device disposed outside the delivery device,
wherein the second display device recognizes a distance to an object approaching from the rear, and has lower brightness as the distance is smaller.

12. The delivery device of claim 11, wherein the second display device displays the company name of the delivery product disposed in each of the storage areas at predetermined time intervals.
